(19) United States
(12) Patent Application Publication
(10) Pub. No.: US 2019/0184778 A1
(43) Pub. Date: Jun. 20, 2019

(54) Traction Increasing Wheel Accessory System

(71) Applicant: Chad Albert, Greenville, MI (US)

(72) Inventor: Chad Albert, Greenville, MI (US)

(21) Appl. No.: 16/222,708

(22) Filed: Dec. 17, 2018

Related U.S. Application Data
(60) Provisional application No. 62/599,161, filed on Dec. 15, 2017.

(51) Int. Cl. B60C 27/20; B60C 27/06

(52) U.S. Cl. CPC B60C 27/20; B60C 27/062

(57) ABSTRACT

A traction increasing wheel accessory system for vehicles includes a plurality of anti-skids, an outer chain, an inner chain, an outer fastener, and an inner fastener. Each anti-skid includes a cross body, an outer shoulder body, and an inner shoulder body. The inner shoulder body is terminally connected to the cross body. The outer shoulder body is terminally connected to the cross body, opposite of the inner shoulder body. The outer chain is externally engaged with the outer shoulder body of each of the plurality of the anti-skids. The inner chain is externally engaged with the inner shoulder body of each of the plurality of the anti-skids. The outer fastener and the inner fastener are terminally attached to each end of the inner chain and the outer chain, thus allowing the accessory system to wrap around a wheel assembly.

The U.S. non-provisional application Ser. No. 15/873,708 claims a priority to a U.S. provisional application Ser. No. 62/599,161 filed on Dec. 15, 2017. The current application is filed on Dec. 17, 2017 while Dec. 15, 2017 was on a weekend.

### FIELD OF THE INVENTION

The present invention relates generally to an accessory for vehicle wheels. More specifically, the present invention relates to a wheel accessory system that is utilized to increase the traction between the ground surface and the wheels.

### BACKGROUND OF THE INVENTION

Snow chains or mud chains are devices fitted to the tires of vehicles to provide maximum traction when driving through snow, ice, mud, or any kind of saturated surfaces. Generally, snow chains or mud chains are attached to the drive wheels of a vehicle or integrated on to a special deploy systems which swing under the tires automatically. Snow chains or mud chains are usually sold in pairs and often must be purchased to match a particular tire size (tire diameter and tread width), although some designs can be adjusted to fit various sizes of tire. Even though driving with snow chains or mud chains reduce fuel efficiency and can change speed of the automobile, they increase traction and braking on snowy or icy surfaces thus improving the overall safety of the vehicle. However, these existing snow chains or mud chains sometimes fail to provide added traction in extreme weather condition due to their basic design concept. Furthermore, these existing snow chains or mud chains tend to loss tension and comes off the wheels during operation due to the standard sizes. Furthermore, these existing snow chains or mud chains do not provide any log-climbing abilities that are useful in off-road environments.

It is an objective of the present invention to provide an improved traction increasing wheel accessory system. The present invention is designed for any vehicle that obtains its forward or backward motion through applying force to a contact surface. The present invention is designed to be used in any industry or any vehicle type. In its preferred embodiment, the present invention can be used on passenger vehicles, dump trucks, semi-tractor trailers, wheeled cranes, graders, fork lifts, boom lifts, motorized man baskets, mining equipment, construction equipment, logging equipment, pickup trucks, sport utility vehicles, UTV's, ATV's, etc. The present invention is specifically designed to assist in conditions associated with snow, ice, high moisture soils, loose soils, and debris such as in landfills, woodlands, etc. Configuration of the present invention further reduces material buildup, such as snow compacting, within the device and transfers maximum power to move the vehicle.

### BRIEF DESCRIPTION OF THE DRAWINGS

FIG. 1 is a perspective view of present invention, wherein the present invention is looped around a wheel and showing the detail view taken within section A and B.

FIG. 2 is a perspective detailed-view taken within section B of FIG. 1, showing the outer fastener of the present invention and attachment of the outer fastener to the outer chain.

FIG. 3 is a perspective detailed-view taken within section A of FIG. 1, showing the inner fastener of the present invention and attachment of the inner fastener to the inner chain.

FIG. 4 is a rear view of the present invention, wherein the present invention is in a circular configuration.

FIG. 5 is a side view for one of the plurality of anti-skids showing the terminal configuration of the inner shoulder body, outer shoulder body, inner wall body, and the outer wall body to the cross body.

FIG. 6 is a perspective view for one of the plurality of anti-skids showing the sub components of the inner shoulder body, outer shoulder body, inner wall body, the outer wall body, and the cross body.

FIG. 7 is a sectional view of the present invention, showing the external engagement between the outer shoulder body to the outer chain and the inner shoulder body to the inner chain.

FIG. 8 is a perspective view for one of the plurality of anti-skids showing the sub components of the inner shoulder body, outer shoulder body, and the cross body.

### DETAIL DESCRIPTIONS OF THE INVENTION

All illustrations of the drawings are for the purpose of describing selected versions of the present invention and are not intended to limit the scope of the present invention.

The present invention is traction increasing wheel accessory system for vehicles when driving through snow, ice, mud, or any kind of saturated surfaces. The present invention consists of paddles with an aggressive traction pattern, wherein the paddles are put into a continuous loop around a wheel. The paddles are set perpendicular to the direction of travel between the wheel and the contact surface. When rotational motion/force is applied to the wheel, the present invention latches onto an interface surface of the wheel with a greater transfer of traction force than the wheel would have directly with the contact surface. The present invention then transfers that force to the paddles, with the aggressive traction pattern, and transfers the force to the contact surface to move the vehicle in the desired direction of travel.

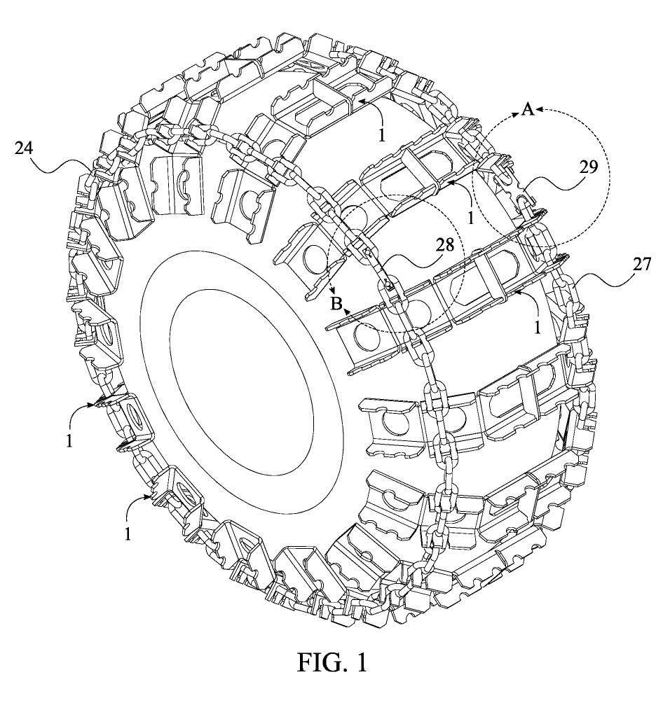

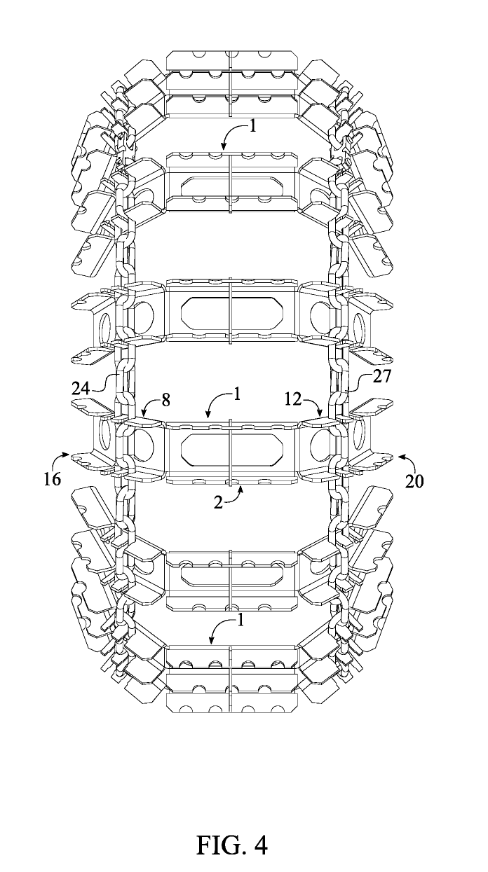

In reference to FIG. 1 and FIG. 4, the present invention comprises a plurality of anti-skids 1, an outer chain 24, an inner chain 27, an outer fastener 28, and an inner fastener 29, wherein each of the plurality of anti-skids 1 comprises a cross body 2, an outer shoulder body 8, and an inner shoulder body 12. In reference to the general configuration of the present invention, the inner shoulder body 12 is terminally connected to the cross body 2 from one end. The outer shoulder body 8 is terminally connected to the cross body 2 from the opposite end and positioned opposite of the inner shoulder body 12. Resultantly, the cross body 2, the outer shoulder body 8, and the inner shoulder body 12 complete the each of anti-skids 1 that is looped around the wheel. The outer chain 24 is externally engaged with the outer shoulder body 8 of each of the plurality of the anti-skids 1 so that the outer chain 24 is able to secure the plurality of the anti-skids 1, adjacent and around the outer sidewall of the tire. The inner chain 27 is externally engaged with the inner shoulder body 12 of each of the plurality of the anti-skids 1 so that the inner chain 27 is able to secure the plurality of the anti-skids 1, adjacent and around the inner sidewall of the tire. The outer fastener 28 is terminally attached to a first end 25 of the outer chain 24. The inner fastener 29 is terminally connected to a first end 25 of the inner chain 27. The outer fastener 28 and the inner fastener 29 either secure to each other delineating a single track-assembly for the present invention or secure to a corresponding fastener of another wheel accessory system delineating multi-track assembly for the present invention. Additionally, alternating distance between each of the plurality of anti-skids 1 allows for a varying traction pattern between the present invention and the contacting surface, increasing the effectiveness of transferring frictional force between the present invention and the contacting surface.

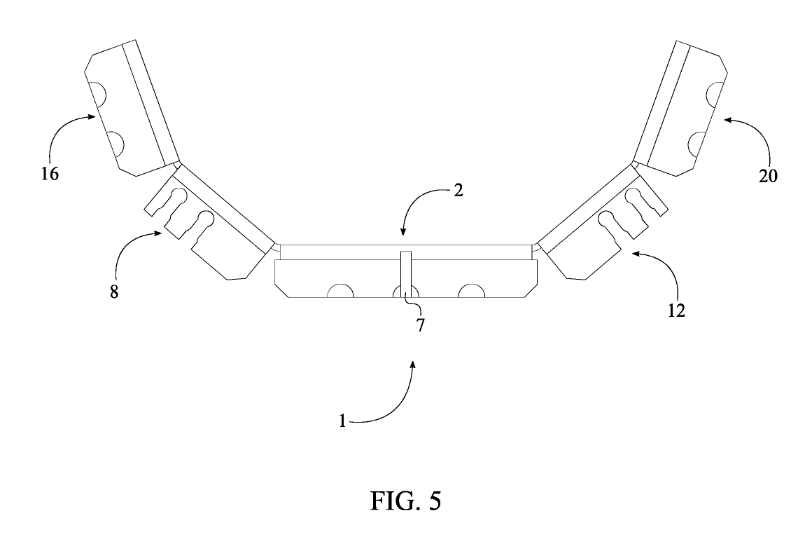

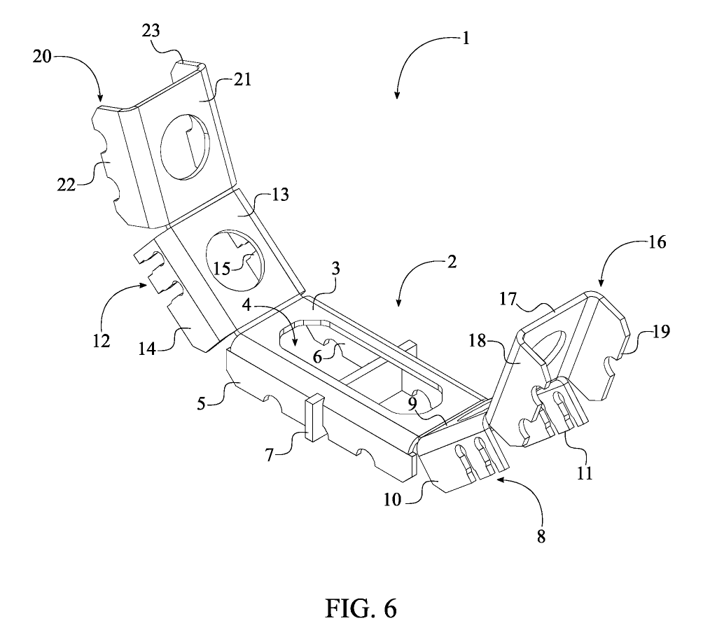

In reference to FIG. 5-6, the cross body 2 that is positioned against the tread area of the tire and comprises a cross plate 3, an opening 4, a first cross tab 5, a second cross tab 6, and a separator wall 7. The cross body 2 is fabricated form a single piece of material to keep manufacturing costs low and provide an economical solution to the consumer. The cross body 2 is preferably fabricated from metal materials or any other types of rigid material that can provide a higher transfer of frictional force in some conditions. The cross plate 3 is positioned adjacent to the tread area of the tire as a slip resistant texture/finish covers a contacting surface of the cross plate 3. The slip resistant texture/finish increases the transfer of friction force from the wheel to the present invention thus minimizing slippage between the contacting surface and the tread area of the tire. The opening 4 traverses through the cross plate 3. More specifically, the opening 4 functions as a channel structure to serve two purposes. First, the opening 4 aids and increases the transfer of friction force between the wheel and present invention about the contacting surface. Second, the opening 4 assists in the release of compacting material between the first cross tab 5, the cross plate 3, and the second cross tab 6.

In reference to FIG. 5-6, the first cross tab 5 is terminally connected along the cross plate 3. The second cross tab 6 is terminally connected along the cross plate 3 and positioned opposite of the first cross tab 5. The opening 4, the first cross tab 5, and the second cross tab 6 are positioned in between the outer shoulder body 8 and the inner shoulder body 12 as the first cross tab 5 and the second cross tab 6 are oriented opposite of the contacting surface. In other words, the first cross tab 5 and the second cross tab 6 are positioned perpendicular to the directional force so that the first cross tab 5 and the second cross tab 6 do not collapse under the gravitational and impact loading. As mentioned before, the first cross tab 5 and the second cross tab 6 assist in the release of compacting material from the cross body 2.

The present invention further comprises alternating tread patterns that are traversed through the first cross tab 5 and the second cross tab 6. The alternating thread patterns aid to break traction lines and increase transfer of friction force between the present invention and the contacting surface. The alternating tread patterns are completed with hardened traction edge for wear resistance and to assist in the transfer of frictional force between the present invention and the contacting surface. Optionally, varying teeth patterns can be cut into the first cross tab 5 and the second cross tab 6 for various surface conditions. For example, one pattern can be produced for the forestry industry, another for mining, yet another for bogs and wetlands, etc. Additionally, the first cross tab 5 and the second cross tab 6 can vary in length, width, thickness, and material for differing supporting surface conditions and different usage. Due to the adjacent positioning of the first cross tab 5 and the second cross tab 6 of each of the plurality of anti-skids 1, the present invention is able to effectively climb snow/ice/mud covered log with respect to tires that are preferably 22 to 35 inches in diameter.

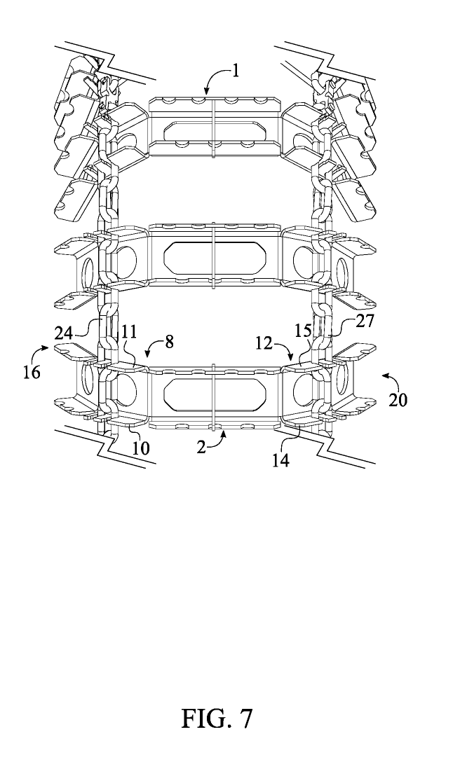

In reference to FIG. 5-6, the separator wall 7 is perpendicularly connected to the cross plate 3, the first cross tab 5, and the second cross tab 6. The separator wall 7 is symmetrically positioned in between the outer shoulder body 8 and the inner shoulder body 12. More specifically, the separator wall 7 improves the structural integrity of the cross plate 3 thus overcoming any structural weakness that may occur due to the positioning of the opening 4. Furthermore, the separator wall 7 also assists in the release of compacting material from the cross body 2 by weakening and separating the compacting material between the first cross tab 5, the cross plate 3, and the second cross tab 6 into two separate area. Furthermore, the separator wall 7 also assists in adding tractive force in the direction lateral to tire rotation. For example, when a vehicle is moving along a slope where the vehicle can be tilted, the separator wall 7 adds lateral load resistance force to the wheels of the vehicle thus reducing lateral sliding. As a result of the reduction of the lateral sliding, when a vehicle is at an “oversteer condition” the axle that is mechanically coupled with the present invention is less likely to fail in a lateral direction relative to the vehicles direction of travel. In reference to FIG. 7, the outer shoulder body 8 that engages with the outer chain 24 is angularly connected to the cross body 2. More specifically, the angular connection between the outer shoulder body 8 and the cross body 2 allow the outer shoulder body 8 to rest up against the outer shoulder area of the tire thus providing a snug placement for the plurality of anti-skids 1. The connection between the outer shoulder body 8 and the cross body 2 delineates a rounded geometry to reduce potential wear points on the wheel at the interface between the tire and the present invention. Furthermore, the outer shoulder body 8 places the outer chain 24 above the ground surface so that positioning of the outer chain 24 does not get tangle with any surface objects such as vine, shrubs, and bushes. The outer shoulder body 8 comprises an outer shoulder plate 9, a first outer shoulder tab 10, and a second outer shoulder tab 11. The first outer shoulder tab 10 is terminally connected along the outer shoulder plate 9 in such a way that the first outer shoulder tab 10 is aligned with the first cross tab 5. The second outer shoulder tab 11 is terminally connected along the outer shoulder plate 9 and positioned opposite of the first outer shoulder tab 10, wherein the second outer shoulder tab 11 is aligned with the second cross tab 6. The first outer shoulder tab 10 and the second outer shoulder tab 11 provide additional lateral friction through the present invention when the wheel is struck or buried in saturated surfaces, also known as a rutting conditions. In other words, a rut is a depression made into the saturated soil surface by the passage of a vehicle or equipment. As the wheel sinks into a rut the first outer shoulder tab 10 and the second outer shoulder tab 11 assist in converting the rotational motion of the wheel into a lifting/forward motion of the vehicle.

In reference to FIG. 5-7, the present invention comprises at least one outer slot. The at least one outer slot traverses through the first outer shoulder tab 10 and the second outer shoulder tab 11 so that the outer chain 24 can be externally engaged with the first outer shoulder tab 10 and the second outer shoulder tab 11. More specifically, the outer chain 24 is snapped/pressed into the at least one outer slot so that the outer chain 24 does not disengaged after being snapped/pressed due to reduced distance between channel tabs that allow the outer chain 24 to be inserted. In other words, the distance between the channel tabs is less than the diameter of the at least one slot.

In reference to FIG. 7, the inner shoulder body 12 that engages with the inner chain 27 is angularly connected to the cross body 2. More specifically, the angular connection between the inner shoulder body 12 and the cross body 2 allow the inner shoulder body 12 to rest up against the inner shoulder area of the tire thus providing a snug placement for the plurality of anti-skids 1. The connection between the inner shoulder body 12 and the cross body 2 delineates a rounded geometry to reduce potential wear points on the wheel at the interface between the tire and the present invention. Furthermore, the inner shoulder body 12 places the inner chain 27 above the ground surface so that positioning of the inner chain 27 does not get tangle with any surface objects such as vine, shrubs, and bushes. The inner shoulder body 12 comprises an inner shoulder plate 13, a first inner shoulder tab 14, and a second inner shoulder tab 15. The first inner shoulder tab 14 is terminally connected along the inner shoulder plate 13 in such a way that the first inner shoulder tab 14 is aligned with the first cross tab 5. The second inner shoulder tab 15 is terminally connected along the inner shoulder plate 13 and positioned opposite of the first inner shoulder tab 14, wherein the second inner shoulder tab 15 is aligned with the second cross tab 6. The first inner shoulder tab 14 and the second inner shoulder tab 15 provide additional lateral friction through the present invention when the wheel is struck or buried in saturated surfaces, also known as a rutting conditions. In other words, a rut is a depression made into the saturated soil surface by the passage of a vehicle or equipment. As the wheel sinks into a rut the first inner shoulder tab 14 and the second inner shoulder tab 15 assist in converting the rotational motion of the wheel into a lifting/forward motion of the vehicle.

In reference to FIG. 5-7, the present invention comprises at least one inner slot. The at least one inner slot traverses through the first inner shoulder tab 14 and the second inner shoulder tab 15 so that the inner chain 27 can be externally engaged with the first inner shoulder tab 14 and the second inner shoulder tab 15. More specifically, the inner chain 27 is snapped/pressed into the at least one inner slot so that the inner chain 27 does not disengaged after being snapped/pressed due to reduced distance between channel tabs that allow the inner chain 27 to be inserted. In other words, the distance between the channel tabs is less than the diameter of the at least one slot.

Furthermore, the outer shoulder body 8 and the inner shoulder body 12 function as alignment members within the present invention so that the present invention can be secured and properly placed upon the wheel under various loading conditions. More specifically, the outer shoulder body 8 and the inner shoulder body 12 maintain the shoulder areas of the tire symmetrical to the cross body 2. The outer shoulder body 8 and the inner shoulder body 12 also create a two points of contact that are offset from the contacting surface. As a result, the outer shoulder body 8 and the inner shoulder body 12 generate a binding condition between the wheel and the present invention further increasing the traction force.

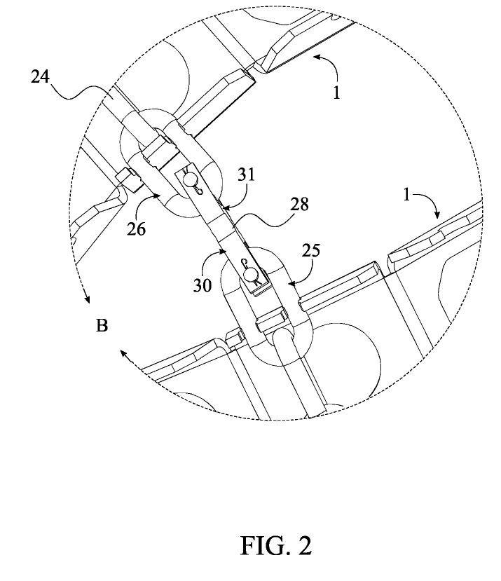

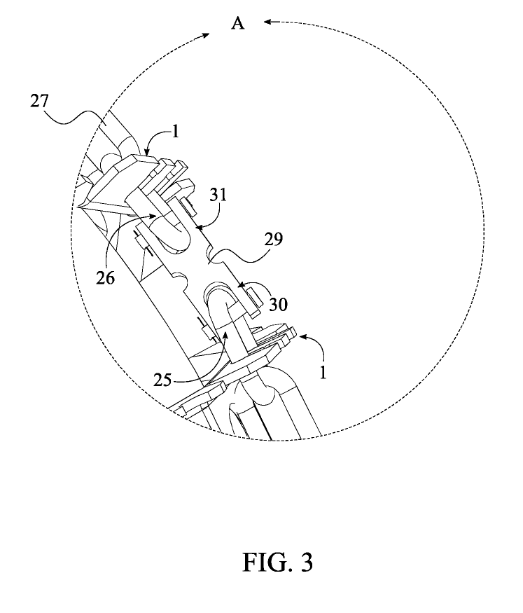

In reference to FIG. 2-3, the outer fastener 28 and the inner fastener 29 each comprises a first fastener section 30 and a second fastener section 31. The outer fastener 28 and the inner fastener 29 enable the ends of the outer chain 24 and the inner chain 27 to be connected to each other or to a corresponding fastener of another wheel accessory system. More specifically, the first fastener section 30 of the outer fastener 28 is attached to the first end 25 of the outer chain 24. The second fastener section 31 of the outer fastener 28 is attached to the second end 26 of the outer chain 24. Resultantly, the first fastener section 30 and the second fastener section 31 for the outer fastener 28 are able to mount the first end 25 and the second end 26 of the outer chain 24 into each other. The first fastener section 30 of the inner fastener 29 is attached to the first end 25 of the inner chain 27. The second fastener section 31 of the inner fastener 29 is attached to the second end 26 of the inner chain 27. Resultantly, the first fastener section 30 and the second fastener section 31 for the inner fastener 29 are able to mount the first end 25 and the second end 26 of the inner chain 27 into each other. Depending on the diameter of a wheel, the wheel may require a single wheel accessory system or a multiple wheel accessory system due to the weight of the present invention.

For example, when a wheel requires a single wheel accessory system to fully cover the diameter of the wheel, the first fastener section 30 and the second fastener section 31 of the outer fastener 28 secures the outer chain 24 around the wheel. Similarly, the first fastener section 30 and the second fastener section 31 of the inner fastener 29 secures the inner chain 27 around the wheel thus looping the single wheel accessory system around the wheel. When a wheel requires a first wheel accessory system and a second wheel accessory system to fully cover the diameter of the wheel, the second fastener section 31 for the outer fastener 28 and the inner fastener 29 of the first wheel accessory system are respectively attached to the second end 26 for the outer chain 24 and the inner chain 27 of the second wheel accessory system. Then, the second fastener section 31 for the outer fastener 28 and the inner fastener 29 of the second wheel accessory system are respectively attached to the second end 26 for the outer chain 24 and the inner chain 27 of the first wheel accessory system

In reference to FIG. 5-6, the present invention further comprises an outer wall body 16 that provides additional assist in converting the rotational motion of the wheel into a lifting/forward motion of the vehicle with respect to the outer sidewall of the tire. More specifically, the outer wall body 16 is terminally connected to the outer shoulder body 8 and positioned opposite of the cross body 2. The outer wall body 16 comprises an outer wall plate 17, a first outer wall tab 18, and a second outer wall tab 19 as shown in FIG. 1. The outer wall plate 17 functions as the base structure in order to connect the first outer wall tab 18 and the second outer wall tab 19. More specifically, the first outer wall tab 18 is terminally connected along the outer wall plate 17. The second outer wall tab 19 is terminally connected along the outer wall plate 17, opposite of the first outer wall tab 18. As a result, the first outer wall tab 18 and the second outer wall tab 19 provide lateral friction for the outer sidewall of the tire.

In reference to FIG. 5-6, the present invention further comprises an inner wall body 20 that provides additional assist in converting the rotational motion of the wheel into a lifting/forward motion of the vehicle with respect to the inner sidewall of the tire. More specifically, the inner wall body 20 is terminally connected to the inner shoulder body 12 and positioned opposite of the cross body 2. The inner wall body 20 comprises an inner wall plate 21, a first inner wall tab 22, and a second inner wall tab 23 as shown in FIG. 1. The inner wall plate 21 functions as the base structure in order to connect the first inner wall tab 22 and the second inner wall tab 23. More specifically, the first inner wall tab 22 is terminally connected along the inner wall plate 21. The second inner wall tab 23 is terminally connected along the inner wall plate 21, opposite of the first inner wall tab 22. As a result, the first inner wall tab 22 and the second inner wall tab 23 provide lateral friction for the inner sidewall of the tire.

Furthermore, the outer wall body 16 and the inner wall body 20 function as alignment members within the present invention so that the present invention can be secured and properly placed upon the wheel under various loading conditions. More specifically, the outer wall body 16 and the inner wall body 20 maintain the sidewalls of the tire symmetrical to the cross body 2. The outer wall body 16 and the inner wall body 20 also create a two points of contact that are offset from the contacting surface. As a result, the outer wall body 16 and the inner wall body 20 generate a binding condition between the wheel and the present invention further increasing the traction force.

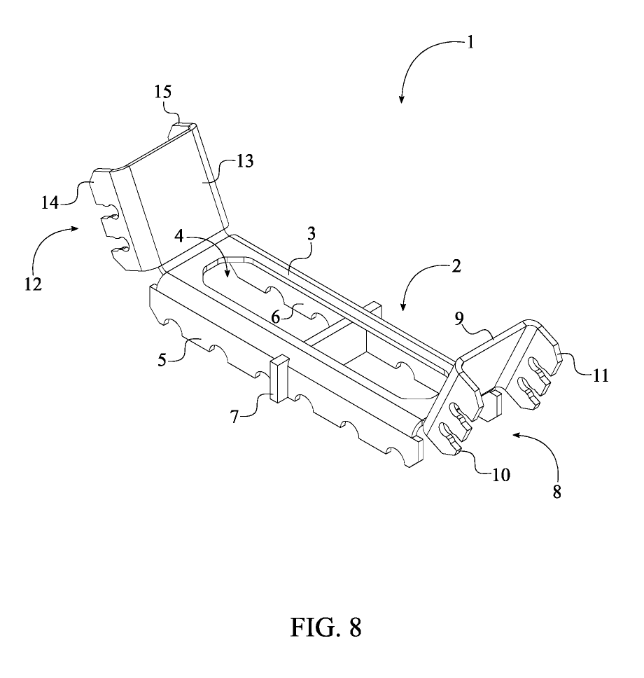

The plurality of the anti-skids 1 can be configured with or without the outer wall body 16 and the inner wall body 20. More specifically, curvature for the tread area of the tire determines which embodiment of the plurality of the anti-skids 1 is required with the present invention. For example, when the tread area of the tire is generally curved, the present invention utilizes the plurality of the anti-skids 1 shown in FIG. 5 so that the outer wall body 16 and the inner wall body 20 are able to fully support the tire along with the outer shoulder body 8 and the inner shoulder body 12. When the tread area of the tire is generally flat, the present invention utilizes the plurality of the anti-skids 1 shown in FIG. 8 thus eliminating the outer wall body 16 and the inner wall body 20 as the outer shoulder body 8 and the inner shoulder body 12 are sufficient enough to fully support the tire.

Although the invention has been explained in relation to its preferred embodiment, it is to be understood that many other possible modifications and variations can be made without departing from the spirit and scope of the invention as hereinafter claimed.

What is claimed is:

1. A traction increasing wheel accessory system for vehicles comprises:
a plurality of anti-skids;
an outer chain;
an inner chain;
an outer fastener;
an inner fastener;
each of the plurality of anti-skids comprises a cross body, an outer shoulder body, and an inner shoulder body;
the inner shoulder body being terminally connected to the cross body;
the outer shoulder body being terminally connected to the cross body, opposite of the inner shoulder body;
the outer chain being externally engaged with the outer shoulder body of each of the plurality of the anti-skids;
the inner chain being externally engaged with the inner shoulder body of each of the plurality of the anti-skids;
the outer fastener being terminally attached to a first end of the outer chain; and
the inner fastener being terminally attached to a first end of the inner chain.

2. The traction increasing wheel accessory system for vehicles as claimed in claim 1 comprises:
the cross body comprises a cross plate, an opening, a first cross tab, a second cross tab, and a separator wall;
the opening traversing through the cross plate;
the first cross tab being terminally connected along the cross plate;
the second cross tab being terminally connected along the cross plate, opposite of the first cross tab;
the opening, the first cross tab, and the second cross tab being positioned in between the outer shoulder body and the inner shoulder body;
the separator wall being perpendicularly connected to the cross plate, the first cross tab, and the second cross tab; and
the separator wall being symmetrically positioned in between the outer shoulder body and the inner shoulder body.

3. The traction increasing wheel accessory system for vehicles as claimed in claim 1, wherein the outer shoulder body being angularly connected to the cross body.

4. The traction increasing wheel accessory system for vehicles as claimed in claim 1 comprises:
the outer shoulder body comprises an outer shoulder plate, a first outer shoulder tab, and a second outer shoulder tab;
the first outer shoulder tab being terminally connected along the outer shoulder plate; and
the second outer shoulder tab being terminally connected along the outer shoulder plate, opposite of the first outer shoulder tab.

5. The traction increasing wheel accessory system for vehicles as claimed in claim 1, wherein the outer chain being externally engaged with a first outer shoulder tab and a second outer shoulder tab of the outer shoulder body.

6. The traction increasing wheel accessory system for vehicles as claimed in claim 1 comprises:
the inner shoulder body being angularly connected to the cross body;

7. The traction increasing wheel accessory system for vehicles as claimed in claim 1 comprises:
the inner shoulder body comprises an inner shoulder plate, a first inner shoulder tab, and a second inner shoulder tab;
the first inner shoulder tab being terminally connected along the inner shoulder plate; and
the second inner shoulder tab being terminally connected along the inner shoulder plate, opposite of the first inner shoulder tab.

8. The traction increasing wheel accessory system for vehicles as claimed in claim 1, wherein the inner chain being externally engaged with a first inner shoulder tab and a second inner shoulder tab of the inner shoulder body.

9. The traction increasing wheel accessory system for vehicles as claimed in claim 1 comprises:
the outer fastener and the inner fastener each comprises a first fastener section and a second fastener section;
the first fastener section of the outer fastener being attached to the first end of the outer chain;
the second fastener section of the outer fastener being attached to the second end of the outer chain;
the first fastener section of the inner fastener being attached to the first end of the inner chain; and
the second fastener section of the inner fastener being attached to the second end of the inner chain.

10. The traction increasing wheel accessory system for vehicles as claimed in claim 1 comprises:
the outer wall body being terminally connected to the outer shoulder body; and
the outer wall body being positioned opposite of the cross body.

11. The traction increasing wheel accessory system for vehicles as claimed in claim 10 comprises:
the outer wall body comprises an outer wall plate, a first outer wall tab, and a second outer wall tab;
the first outer wall tab being terminally connected along the outer wall plate; and
the second outer wall tab being terminally connected along the outer wall plate, opposite of the first outer wall tab.

12. The traction increasing wheel accessory system for vehicles as claimed in claim 1 comprises:
the inner wall body being terminally connected to the inner shoulder body; and
the inner wall body being positioned opposite of the cross body.

13. The traction increasing wheel accessory system for vehicles as claimed in claim 12 comprises:
the inner wall body comprises an inner wall plate, a first inner wall tab, and a second inner wall tab;
the first inner wall tab being terminally connected along the inner wall plate; and
the second inner wall tab being terminally connected along the inner wall plate, opposite of the first inner wall tab.
